(19) United States
(12) Patent Application Publication
(10) Pub. No.: US 2026/0127895 A1
(43) Pub. Date: May 7, 2026

(54) LANE LINE MARKING TYPE ESTIMATION AND MARKING TYPE CHANGE DETECTION USING TEMPORAL SEMANTIC SEGMENTATION INFORMATION

(71) Applicant: QUALCOMM Incorporated, San Diego, CA (US)

(72) Inventors: Markus Petersson, LINKÖPING (SE); Adam Aili, Hallsberg (SE)

(21) Appl. No.: 18/934,333

(22) Filed: Nov. 1, 2024

(51) Int. Cl. G06V 20/56; G06V 10/26; G06V 10/75; G06V 10/776

(52) U.S. Cl. CPC G06V 20/588; G06V 10/26; G06V 10/751; G06V 10/776

(57) ABSTRACT

An apparatus includes a memory for storing image data; and processing circuitry in communication with the memory. The processing circuitry is configured to obtain a current set of one or more camera images from a current time, calculate lane marking confidence values for two or more lane marking types at various positions in a scene captured by the images, and determine the lane marking type for each position by comparing these confidence values with previously stored confidence values associated with the same positions. The apparatus then outputs the lane marking type for each position in the scene.

### TECHNICAL FIELD

This disclosure relates to sensor systems, including image projections for use in advanced driver-assistance systems (ADAS).

### BACKGROUND

An autonomous driving vehicle is a vehicle that is configured to sense the environment around the vehicle, such as the existence and location of objects, and to operate without human control. An autonomous driving vehicle may include cameras that produce image data that may be analyzed to determine the existence and location of other objects around the autonomous driving vehicle. A vehicle having advanced driver-assistance systems (ADAS) is a vehicle that includes systems which may assist a driver in operating the vehicle, such as parking or driving the vehicle.

### SUMMARY

The present disclosure generally relates to techniques and devices for detecting and estimating lane marking locations, lane marking types, and lane marking change locations using temporal semantic segmentation information. For example, aspects of the disclosure may obtain one or more current camera images capturing a forward view of a lane of travel and locate lane markings and calculate confidence values for the lane markings in relation to a subject vehicle within the lane of travel. For instance, a processing system may calculate current confidence values for solid lane markings and confidence values for dashed lane markings within the forward view along the lane of travel in relation to the subject vehicle. The current confidence values may be stored and subsequently referenced as prior frame confidence values. The current and prior confidence values may be compared to evaluate whether the type of lane markings and then also to determine whether a change in lane marking type has occurred (e.g., to determine whether the lane markings have transitioned from solid to dashed or dashed to solid), as well as determine a point at which the transition occurs in relation to the subject vehicle. Previously calculated confidence values may be referenced and utilized in conjunction with new lane marking information in real time, until such time that prior lane marking confidence values are no longer within the forward view along the lane of travel in relation to the subject vehicle, at which point the prior lane marking confidence values are no longer relevant and therefore no longer needed.

Because prior lane marking confidence values are utilized as part of the determination of lane marking type, as well as a determination whether the lane markings type has transitioned from solid to dashed or dashed to solid and where such a transition occurs, the determinations may be made with high accuracy from the temporal semantic segmentation information associated with the prior lane marking confidence values, even when lane markings within the forward view become partially or fully occluded and are therefore indeterminate within a current frame of the forward view captured in relation to the subject vehicle.

In one example, an apparatus for processing image data, the apparatus includes a memory for storing the image data; and processing circuitry in communication with the memory. According to such an example, the processing circuitry is configured to obtain a current set of one or more camera images of the image data from a current time. According to certain examples, the apparatus calculates respective lane marking confidence values for two or more lane marking types at a plurality of positions in a scene captured by the current set of one or more camera images. In at least one example, the apparatus determines a lane marking type for each of the plurality of positions based on a comparison of the respective lane marking confidence values with previously-stored lane marking confidence values associated with the plurality of positions in the scene. According to such examples, the apparatus outputs the lane marking type for each of the plurality of positions in the scene.

In another example, a method includes obtaining a current set of one or more camera images of the image data from a current time. In one example, the method includes calculating respective lane marking confidence values for two or more lane marking types at a plurality of positions in a scene captured by the current set of one or more camera images. According to certain examples, the method includes determining a lane marking type for each of the plurality of positions based on a comparison of the respective lane marking confidence values with previously-stored lane marking confidence values associated with the plurality of positions in the scene. In at least one example, the method includes outputting the lane marking type for each of the plurality of positions in the scene.

In another example, a non-transitory computer-readable medium stores instructions that, when executed, cause processing circuitry to obtain a current set of one or more camera images from a current time. In one example, the instructions cause the processing circuitry to calculate respective lane marking confidence values for two or more lane marking types at a plurality of positions in a scene captured by the current set of one or more camera images. According to certain examples, the instructions cause the processing circuitry to determine a lane marking type for each of the plurality of positions based on a comparison of the respective lane marking confidence values with previously-stored lane marking confidence values associated with the plurality of positions in the scene. In at least one example, the instructions cause the processing circuitry to output the lane marking type for each of the plurality of positions in the scene.

In another example, an apparatus includes means for obtaining a current set of one or more camera images of the image data from a current time. In one example, the apparatus includes means for calculating respective lane marking confidence values for two or more lane marking types at a plurality of positions in a scene captured by the current set of one or more camera images. According to certain examples, the apparatus includes means for determining a lane marking type for each of the plurality of positions based on a comparison of the respective lane marking confidence values with previously-stored lane marking confidence values associated with the plurality of positions in the scene. In at least one example, the apparatus includes means for outputting the lane marking type for each of the plurality of positions in the scene.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one or more techniques of this disclosure.

FIG. 2 is a block diagram illustrating an architecture for processing a current input image to generate predictions including lane marking locations and current lane marking confidence values for the lane markings, in accordance with one or more techniques of this disclosure.

FIG. 3 is a flow diagram illustrating view transformation using image data having multiple input images, sensor inputs, or both, to determine a lane marking change location, in accordance with one or more techniques of this disclosure.

FIG. 4 is a conceptual diagram for generating accurate lane marking confidence values using temporal semantic segmentation information, in accordance with one or more techniques of this disclosure.

FIG. 5 is a flow diagram illustrating an example method for detecting and estimating lane line markings and lane marking type changes using temporal semantic segmentation information, in accordance with one or more techniques of this disclosure.

### DETAILED DESCRIPTION

The present disclosure generally relates to techniques and devices for detecting and estimating lane marking locations, lane marking types, and lane marking change locations using temporal semantic segmentation information. For example, aspects of the disclosure may obtain one or more current camera images capturing a forward view of a lane of travel and locate lane markings and calculate confidence values for the lane markings in relation to a subject vehicle within the lane of travel. For instance, a processing system may calculate current confidence values for solid lane markings and confidence values for dashed lane markings within the forward view along the lane of travel in relation to the subject vehicle. The current confidence values may be stored and subsequently referenced as prior frame confidence values. The current and prior confidence values may be compared to evaluate whether a change in lane marking type has occurred (e.g., to determine whether the lane markings have transitioned from solid to dashed or dashed to solid), as well as determine a point at which the transition occurs in relation to the subject vehicle. Previously calculated confidence values may be referenced and utilized in conjunction with new lane marking information in real time, until such time that prior lane marking confidence values are no longer within the forward view along the lane of travel in relation to the subject vehicle, at which point the prior lane marking confidence values are no longer relevant and therefore no longer needed.

Because prior lane marking confidence values are utilized as part of the determination for whether the lane markings have transitioned from solid to dashed or dashed to solid and where such a transition occurs, the determination may be made with high accuracy from the temporal semantic segmentation information associated with the prior lane marking confidence values, even when lane markings within the forward view become partially or fully occluded and are therefore indeterminate within a current frame of the forward view captured in relation to the subject vehicle.

Camera systems may be used in various different robotic, vehicular, and virtual reality (VR) applications. One such vehicular application is an advanced driver assistance system (ADAS). ADAS may be a system that uses camera technology to improve driving safety, comfort, and overall vehicle performance.

In some examples, the camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be used in vehicular, robotic, and VR applications as sources of information that may be used to determine the location, pose, and potential actions of physical objects in the outside world.

Advanced Driver Assistance Systems (ADAS) detect lane markings using high-resolution cameras and advanced image processing techniques. Lane marking detection utilizes cameras and/or sensors on the vehicle to capture real-time images of the road. These images may be preprocessed to enhance quality through adjustments such as distortion correction and contrast enhancement.

Semantic segmentation algorithms are applied to captured image frames to classify pixels in the image into categories, such as lane markings, vehicles, and pedestrians. Convolutional Neural Networks (CNNs) often perform this classification, enabling the identification of lane markings and their types, such as whether the lane markings are dashed or solid.

Once the lane markings are detected, the ADAS system tracks lane markings across multiple frames to monitor their position relative to the vehicle, accounting for changes in the road environment. For instance, the ADAS system analyzes the geometric properties of the lane markings, including orientation and curvature, which aids in predicting the vehicle's path. If the vehicle drifts out of its lane, the ADAS system can trigger alerts or initiate corrective actions, such as steering adjustments.

Prior known techniques focus on determining the location of specific lane markings to facilitate applications such as automated driving or lane departure warning systems. In automated driving contexts, additional information about the lane marking may be useful. For example, identifying the marking type—whether dashed or solid—may be important, as crossing a solid marking during a lane change is prohibited and may be dangerous. Identifying other changes to lane marking types may also be relevant to an ADAS system, such as identifying different colored lines (e.g., white versus yellow), identifying attention markings, identifying double yellow versus dashed yellow markings, identifying wide versus narrow lane markings, and so forth.

The marking type represents a dynamic property that may change. For instance, a lane marking might transition from dashed to solid when approaching a crest, which serves to prevent drivers from overtaking due to an increased risk of collision arising from reduced visibility. Identifying the point at which a marking type changes may also hold significance for other applications, such as mapping or localization.

Estimating the type of a detected lane marking may include analyzing the average dashed and solid confidence values for dashed and solid lane markings using both current lane marking confidence values and prior lane marking confidence values. Semantic segmentation may be applied to an input image to detect lane markings and other objects with corresponding probabilities, such as the probability or likelihood that an object is a lane marking (e.g., versus a tree or other object). Semantic segmentation may optionally produce a probability as output that a detected lane marking is of a given type, such as a dashed or solid lane marking. Alternatively, downstream processing by a lane detector unit may quantify the probabilities that a lane marking detected via semantic segmentation is of a given type (e.g., outputting a probabilities indicating the detected lane marking has a 90% probability of being a solid lane marking type and a 10% probability the lane marking is a dashed lane marking type). Equidistant positions may be taken to generate lane marking locations along the points obtained from semantic segmentation applied to an input image from which the lane markings are detected. However, identifying the specific geographical point or location, relative to a subject vehicle, at which lane markings change from one type to a different type presents challenges. This challenge is made more difficult due to the apparent motion of the lane markings when viewed relative to a subject vehicle. The lane markings appear to move over time within the input images captured by the cameras of the subject vehicle due to the motion of the subject vehicle through the environment.

Furthermore, certain situations complicate the determination of a marking type, even when the lane marking type remains constant. For example, in a traffic jam, if another vehicle within the forward view of the subject vehicle occludes the lane marking, or is positioned directly over a lane marking, identifying the lane marking type from a single current frame corresponding to a current input image becomes particularly challenging or even impossible.

Aspects of the disclosure enable identification of the type of a lane marking (e.g., solid or dashed) including scenarios in which lane markings are occluded, for example, by another vehicle, by utilizing temporal information from multiple frames over time, such as a comparison of both current lane marking confidence values from a current input image with prior lane marking confidence values from one or more prior input images. Additionally, a processing system enables identification of the transition point, called a lane marking change location, in which a lane marking type transitions, for example, from dashed to solid or from solid to dashed. The lane marking change location is identified in relation to the subject vehicle in terms of where and when the transition occurs, so as to provide more precise vehicle control by ADAS equipped vehicles.

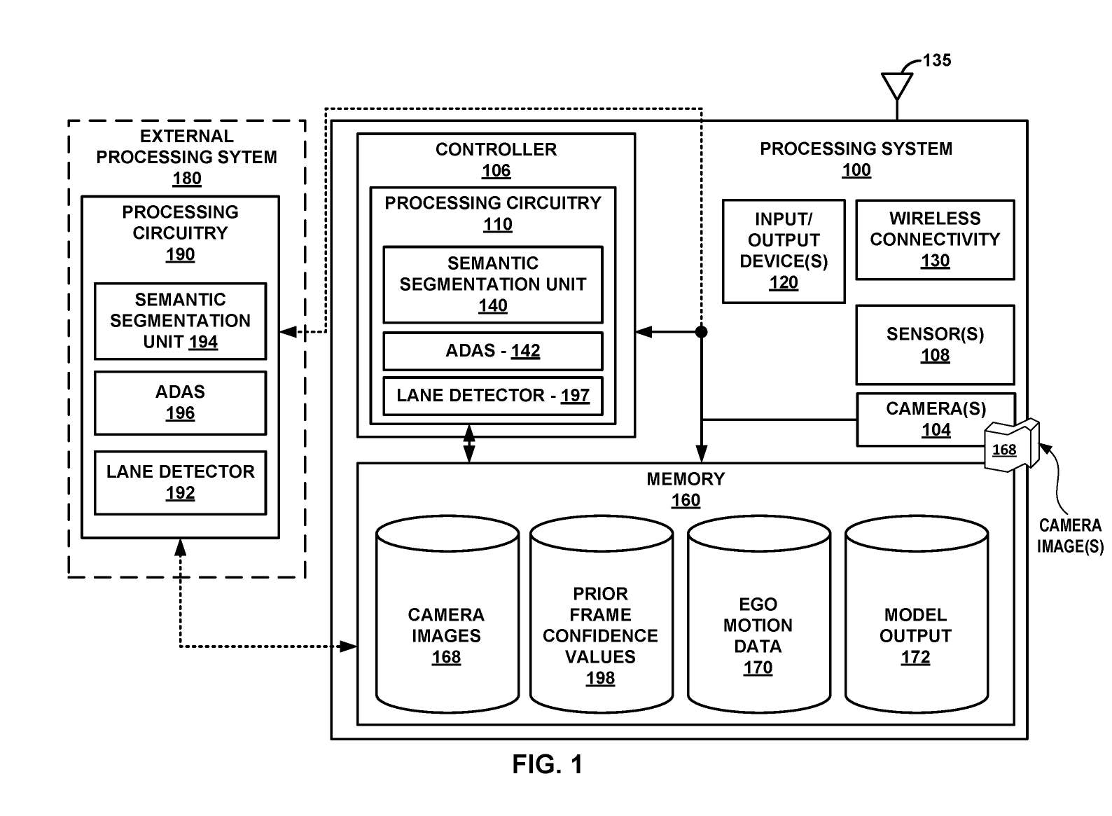

FIG. 1 is a block diagram illustrating an example processing system 100, in accordance with one to more techniques of this disclosure. Processing system 100 may be used in an apparatus, such as a vehicle, including an autonomous driving vehicle or an assisted driving vehicle (e.g., a vehicle having an advanced driver-assistance system (ADAS) or an “ego vehicle”). In such an example, processing system 100 may represent an ADAS. In other examples, processing system 100 may be used in robotic applications, virtual reality (VR) applications, or other kinds of applications that may include both a camera and a LiDAR system. The techniques of this disclosure are not limited to vehicular applications. The techniques of this disclosure may be applied by any system that processes image data and/or position data.

Processing system 100 may include camera(s) 104, controller 106, one or more sensor(s) 108, input/output device(s) 120, wireless connectivity component 130, and memory 160. Camera(s) 104 may be any type of camera configured to capture video or image data in the environment around processing system 100 (e.g., around a vehicle). In some examples, processing system 100 may include multiple cameras 104. For example, camera(s) 104 may include a front-facing camera (e.g., a front bumper camera, a front windshield camera, and/or a dashcam), a back-facing camera (e.g., a backup camera), side-facing cameras (e.g., cameras mounted in sideview mirrors). Camera(s) 104 may be a color camera or a grayscale camera. In some examples, camera(s) 104 may be a camera system including more than one camera sensor. Camera(s) 104 may, in some examples, be configured to collect camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input and/or output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of a vehicle through the environment surrounding the vehicle. Controller 106 may include one or more processors, e.g., processing circuitry 110. Controller 106 is not limited to controlling vehicles. Controller 106 may additionally or alternatively control any kind of controllable object, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure. In some examples, one or more of processing circuitry 110 may be based on an Advanced Reduced Instruction Set Computer (RISC) Machine (ARM) or a RISC five (RISC-V) instruction set.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. In some aspects, sensor(s) 108 may include direct depth sensing sensors, which may function to determine a depth of or distance to objects within the environment surrounding processing system 100 (e.g., the environment surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells. For example, the memory controller may include a row decoder, column decoder, or both. In some cases, memory cells within memory 160 store information in the form of a logical state.

Processing system 100 may be configured to perform techniques for obtaining image data, including one or more current camera images 168 from camera(s) 104 of processing system 100 and applying semantic segmentation utilizing semantic segmentation unit 140 for detecting lane marking objects, determining lane marking types, and localizing lane marking positions using semantic segmentation. Processing system 100 may alternatively be configured to extract camera features, fuse the features, project the camera features into BEV image space to represent a 3D environment surrounding a subject vehicle, to which semantic segmentation unit 140 may apply semantic segmentation to detect and localize lane marking objects. In other examples, semantic segmentation unit 140 detects and localizes lane marking objects within a segmentation map and lane detector 197 predicts the lane marking types using current confidence values for camera image 168 at a current time and or prior frame confidence values 198 stored for camera images 168 previously processed.

Regardless of the manner image information is processed, processing system 100 is configured to determine a lane of travel (e.g., a track) for a subject vehicle, determine lane marking types, determine lane marking positions (e.g., lane marking locations) in relation to a subject vehicle, determine a lane marking change location where a change to the type of lane line markings occurs (e.g., solid to dashed or dashed to solid lane line markings) in relation to the subject vehicle, or some combination thereof.

Semantic segmentation unit 140 may be implemented in software, firmware, and/or any combination of hardware described herein. Semantic segmentation unit 140 may be configured to receive or obtain camera images 168 captured by camera(s) 104. Semantic segmentation unit 140 may be configured to receive camera images 168 directly from camera(s) 104, or from memory 160. In some examples, the plurality of camera images 168 may be referred to herein as “image data.” Moreover, camera images 168 may include static images, video imagery, a video stream, LiDAR data, radar data, or some combination thereof.

Lane detector 197 may be implemented in software, firmware, and/or any combination of hardware described herein. Lane detector 197 may be configured to obtain, as input, a segmentation map generated as output from semantic segmentation unit 140. Lane detector 197 enables off-loading of computational burdens from semantic segmentation unit 140 by applying additional post-processing information derived from current camera images 168, such as determining lane marking locations and lane marking types based at least in part on current frame confidence values represented within a segmentation map output by semantic segmentation unit 140 and prior frame confidence values 198 stored within memory 160. Lane detector 197 may also utilize ego motion data 170 stored within memory 160 to match up currently detected lane marking objects associated with current camera images 168 with previously detected lane marking objects detected from prior camera images 168. Similarly, lane detector 197 may utilize ego motion data 170 stored within memory 160 to match up current frame confidence values for a given lane marking object with prior frame confidence values 198. Such a matching operation enables lane detector 197 to compare the same or corresponding lane marking objects over time (e.g., temporal comparisons made between a current camera image 168 and a previously processed camera image 168). Such lane markings will be in different locations relative to the subject vehicle, assuming the subject vehicle is moving, but may nevertheless be matched together using ego motion data 170 which tracks the movement of the ego vehicle, enabling current and prior frame confidence values for each given lane marking object to be matched and compared. In some examples, current and prior frame confidence values for each one of multiple lane markings are averaged or weighted to compute a single aggregated lane marking confidence value for each lane marking object which remains within a forward view of the subject vehicle. In other examples, current and prior frame confidence values for each one of multiple lane markings are monitored for changes, such as a reduction or increase in confidence value satisfying a change threshold. Such a change may indicate, for example, a previously viewable lane marking object is now occluded within a current frame or alternatively, a previously ambiguously detected lane marking object (e.g., with a 50% probability of being a dashed lane marking and a 50% probability of being a solid lane marking) is now viewable and determinable with a high degree of confidence (e.g., 80% or some other configurable threshold) within a current frame.

In some examples, lane detector 197 may operate in conjunction within semantic segmentation unit 140 of processing system 100. Similarly, lane detector 192 may operate within processing circuitry 190 of external processing system 180 and may optionally be configured to operate in conjunction within semantic segmentation unit 194 of external processing system 180 to offload computational burdens from semantic segmentation unit 194. In such examples, lane detector 192, 197 obtains output from semantic segmentation unit 140, 194 such as objects detected within a scene captured by camera images 168 and probabilities for the objects detected within the scene. For example, consider a subject vehicle traversing a “track” or path along a roadway traveled by the subject vehicle. In such an example, semantic segmentation unit 140, 194 may sample the track at equidistant points, such as every two feet or every meter, and generate as output, lane marking classifications and probabilities corresponding to each of the multiple positions sampled along the track corresponding to the multiple equidistant points. Therefore, if the forward view of the subject vehicle represented within camera images 168 is 100 feet, by way of example only, and the equidistant sampling is configured to every two feet, again, by way of example only, then output from semantic segmentation unit 140, 194 may indicate lane markings at 50 different positions along the track of the vehicle specifying lane marking objects as detected at those positions and the lane marking type probabilities for the detected lane marking objects. Very specifically, semantic segmentation unit 140, 194 may indicate, for each respective location sampled, a lane marking object with corresponding confidence values for the lane marking type of the lane marking object, such as 90% confidence the lane marking type is dashed and 10% confidence the lane marking type is solid. These current confidence value indications would be provided for every one of the lane marking objects sampled from the scene (e.g., 50 distinct locations in this particular example) and then stored into memory 160 as prior frame confidence values 198 for future reference.

Lane detector 192, 197 may apply post-processing operations to detect, determine, and localize lane line markings based on currently detected frame confidence values and prior frame confidence values 198 available to processing system 100 and/or external processing system 180. By localizing the lane marking information utilizing lane detector 192, 197, a machine learning model may apply its convolution capacity to the building of abstract features resulting in improved predictive output, such as more accurate detection of lane marking type objects, more accurate depth estimation to lane marking type objects, and an overall improved model representation of the real-world environment within which a subject vehicle is operating.

The relative motion and location of a subject vehicle captured by ego motion data 170 is stored within memory 160. Ego motion data 170 refers to the motion of the camera or the subject vehicle to which the camera is attached as it moves through its environment. When referring to an ego-vehicle in the context of autonomous driving, ego motion data 170 stored within memory 160 describes the movement of the vehicle, including changes in position, orientation, velocity, and acceleration as the vehicle navigates through space relative to other objects within the environment.

Ego motion data 170 may indicate, for example, 3D coordinates (x, y, z) of a subject vehicle at different points in time. Ego motion data 170 may also indicate one or more of speed, changes in acceleration, and pose data of the ego vehicle. Pose data refers to the position and orientation of the subject vehicle in a specific coordinate frame, typically indicating both position (in terms of x, y, z coordinates) and orientation (e.g., represented as yaw, pitch, and roll angles). Objects detected within a current frame of camera images 168, such as lane markings, may be matched with corresponding objects detected within prior frames of camera images 168 based on overlapping or matching positions of the objects within each of the current and prior frames or by offsetting the positions of objects using the relative motion of the subject vehicle through an environment utilizing the ego motion data 170 so as to produce the same, similar, or overlapping objects over time as represented within current and prior frames of camera images.

Similarly, current confidence values for lane markers within a current frame of camera images 168 may be matched with prior frame confidence values 198 for corresponding lane markers detected within prior frames of camera images 168 using the 3D coordinates or other positional data (e.g., velocity or relative movement of the vehicle in relation to the detected lane markers, etc.) stored for a subject vehicle by ego motion data 170. For example, if camera images 168 captured by an autonomous vehicle depict stationary objects such as lane markers, trees, and buildings that appear to shift, the apparent relative movement of such stationary objects is due to the ego motion of the subject vehicle which may be determined utilizing ego motion data 170. Utilizing ego motion data 170 to interpret the ego motion of the subject vehicle relative to the stationary lane markings enables lane detector 197 to match the confidence values for corresponding lane markers along a track traversed by the subject vehicle (e.g., the same lane markers along the road or path of travel) across current camera images 168 and prior camera images 168. Specifically, ego motion data 170, enables lane detector 197 to match the current confidence values for a lane marker within current camera image 168 data for a current time (e.g., 50% confidence the current lane marker type is a dashed line marker and 50% confidence the current lane marker type is a solid lane marker) with prior frame confidence values 198 for the same or corresponding lane marker within previous camera image data 168 captured at one or more previous times (e.g., 90% confidence the current lane marker type is a dashed line marker and 10% confidence the current lane marker type is a solid lane marker). By matching and then comparing the current and prior lane confidence values, lane detector 197 may produce a higher confidence or higher accuracy prediction regarding a lane marking type for each lane marking object evaluated as well as generating an accurate prediction of a lane marking change location indicating the point or location relative to a subject vehicle where lane markings transition from one type (e.g., solid) to another type (e.g., dashed).

In some examples, processing circuitry 110 may be configured to train one or more machine learning models such as encoders, decoders, positional encoding models, or any combination thereof applied by semantic segmentation unit 140 using training data. For example, training data may include one or more training camera images along with ground truth data from a range sensor such as a LiDAR sensor. Training data may additionally or alternatively include features known to accurately represent one or more point cloud frames and/or features known to accurately represent one or more camera images. This may allow processing circuitry 110 to train an encoder to generate features that accurately represent camera images.

Processing circuitry 110 of controller 106 may apply ADAS 142 to control an object (e.g., a vehicle, a robotic arm, or another object that is controllable based on the output from semantic segmentation unit 140 and/or lane detector 192, 197) corresponding to processing system 100. ADAS 142 may control the object based on information included in the output generated by semantic segmentation unit 140 relating to one or more objects within a 3D space including processing system 100. For example, the output generated by semantic segmentation unit 140 may include pixel classification, classifications for regions of an image, an identity of one or more objects, a position of one or more objects relative to the processing system 100, characteristics of movement (e.g., speed, acceleration) of one or more objects, or any combination thereof. Based on this information, ADAS 142 may control the object corresponding to processing system 100. The output from semantic segmentation unit 140 may be stored in memory 160 as model output 172.

Semantic segmentation unit 140 refers to a part of an artificial intelligence model that performs semantic segmentation, which involves classifying regions of an image or every pixel in an image into one of several predefined categories. For example, in an image of a forward view of a “track” or path traveled by a vehicle (e.g., a road, street, etc.), semantic segmentation unit 140 may assign each pixel a label such as “lane marking,” “road,” “car,” “building, “tree,” and so forth, to generate a pixel-wise understanding of camera image 168, so that all parts of camera image 168 are segmented into different semantic regions. Semantic segmentation unit 140 may output a segmentation map in which regions are labeled or bounded by object identifiers, such as lane marking object, tree, car, etc.

In some examples, semantic segmentation unit 140, 194 assigns labels to objects in the scene, such as tree, car, lane marking, and lane detector 192, 197 applies post-processing to the lane marking objects. In other examples, lane detector 192, 197 obtains as input, a segmentation map output by semantic segmentation unit 140, 194 specifying probabilities for detected objects and lane detector 192, 197 determines lane marking objects and generates probabilities for lane marking types using the segmentation map. In other examples, lane detector 192, 197 may sample the segmentation map output by semantic segmentation unit 140, 194 along equidistant points of a track (e.g., every two feet of the roadway) to identify lane markings at multiple locations and determine lane marking type probabilities for each lane marking corresponding to each respective location sampled. For instance, lane detector 192, 197 may determine from the segmentation map output from semantic segmentation unit 140, 194 lane marking type probabilities corresponding to one or more of a dashed lane marking, a solid lane marking, a yellow lane marking, a white lane marking, a double lane marking, an attention lane marking, a toll lane marking, a tunnel lane marking, crosswalk markings, and so forth. In some examples, lane detector 192, 197 operates on pixel-wise output generated by semantic segmentation unit 140, 194 provided using a segmentation map. In such an example, lane detector 192, 197 may apply labels to sub-regions of camera image 168, such as “lane marking” or the sub-types of lane markings specified above, including dashed lane marking, solid lane marking, etc., based on the contents of camera image 168. Stated differently, lane detector 192, 197 determines which lane marking type, among a set of enumerated possible lane marking types, the sub-regions within the image or objects identified within the image most likely correspond (e.g., 90% solid lane marking type and 10% dashed lane marking type, etc.).

Semantic segmentation unit 140 may iteratively operate on a single camera image 168 one at a time by processing and assigning a class label to every region or pixel within the single camera image 168. The output from semantic segmentation unit 140 may include a segmentation map, where each pixel of the single camera image 168 is categorized into a particular class (e.g., lane marking, road, car, tree, sky, etc.).

In the context of computer vision, an optional BEV unit enables processing of multiple current camera images 168 obtained at a single point in time. Such a BEV unit may transform the multiple camera images 168 into a unified top-down view, referred to as a BEV view, as if looking at a scene from above. A BEV view may enable downstream tasks, such as controlling a vehicle via autonomous driving applications or manipulating an object, such as utilizing robotics control applications.

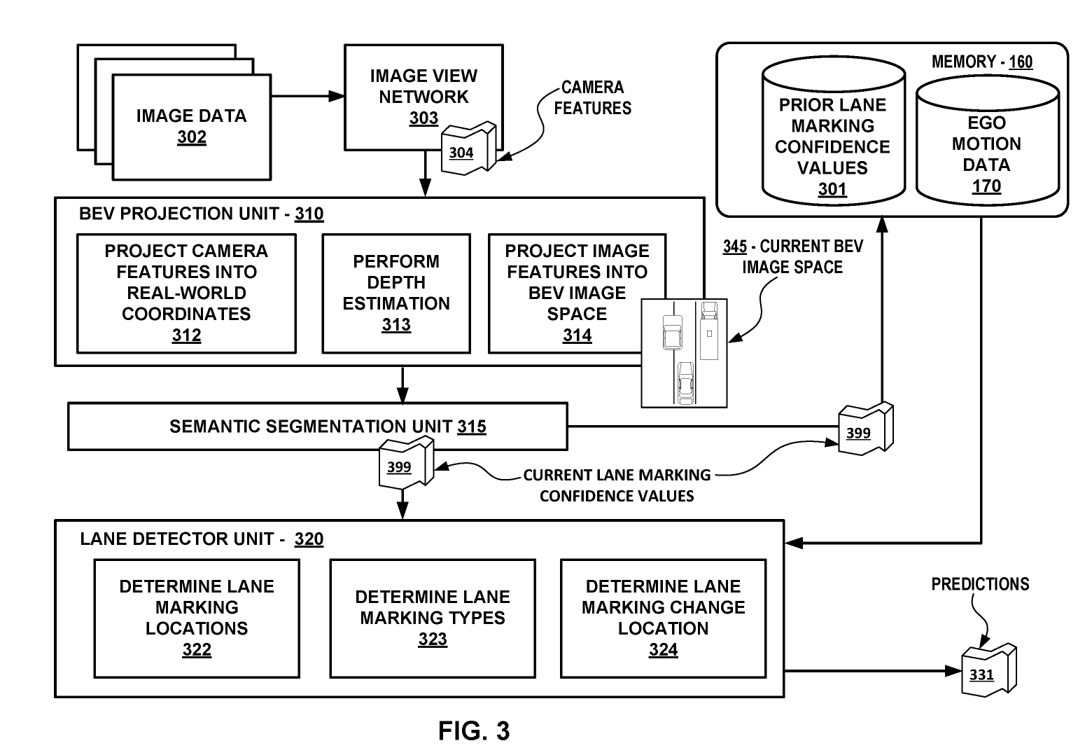

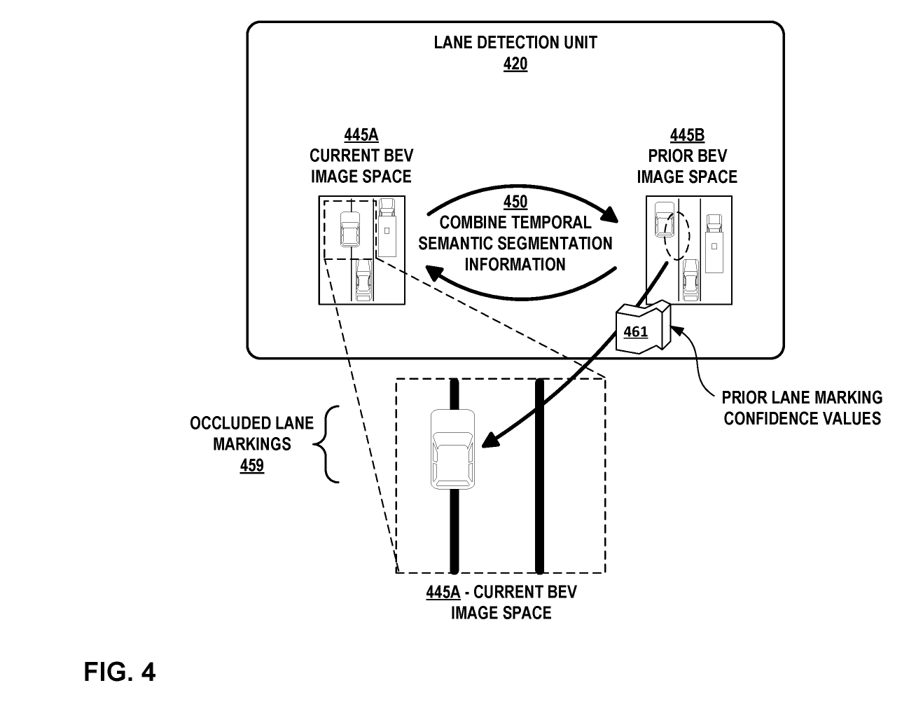

In examples utilizing an optional BEV unit, multiple camera images 168 (e.g., from multiple cameras and/or multiple sensors of a subject vehicle) are obtained and processed corresponding to a single point in time. A collection of such camera images 168 (e.g., current camera images 168) representing a single point in time may therefore be processed utilizing a Bird's Eye View (BEV) processing unit (e.g., refer to FIGS. 3 and 4). Subsequent to generation of a BEV image space, semantic segmentation unit 140 may generate a segmentation map with each region or pixel labeled or categorized into a particular class (e.g., lane marking, road, car, tree, sky, etc.).

For example, processing system 100 configured with an optional BEV unit may generate a BEV view from multiple camera images 168 originating from multiple sensors or cameras (such as front, side, and rear cameras in vehicles), each captured from different angles. In such an example, camera images 168 are then geometrically transformed using perspective correction, warping, and stitching techniques to align them into a single top-down map. The transformation typically involves projecting the camera’s 2D perspective into a common ground plane, using the known geometry of the cameras and the environment.

The BEV unit then fuses these images to create a complete 360-degree BEV view around the subject vehicle. This allows for easier detection of objects (such as lane markings, cars, pedestrians, or obstacles) because the spatial relationships between objects can be better understood from a bird’s-eye perspective.

The techniques of this disclosure may also be performed by external processing system 180. That is, encoding input data, applying semantic segmentation to detect objects utilizing semantic segmentation unit 140, 194, and optionally generating camera features utilizing an optionally configured BEV unit to generate BEV images, may be performed by a processing system that does not include the various sensors shown for processing system 100. Such a process may be referred to as “offline” data processing, where the output is determined from camera images 168 received from processing system 100. External processing system 180 may send an output to processing system 100 (e.g., an ADAS or vehicle).

While lane detector 197 is depicted as part of processing circuitry 110 for controller 106, lane detector 192 may optionally be included within processing circuitry 190 for external processing system 180. For instance, lane detector 192 may be included within external processing system 180 for computer vision operations which are less time-sensitive, more computationally burdensome, or generally more resilient to operational latencies. In other examples, lane detector 197 and 192 units are included in both processing circuitry 110 of controller 106 and also within external processing system 180 respectively, thus enabling certain computer vision tasks to be performed offline, off-loaded into the cloud, and/or performed by external processing system 180 with low-latency operations being performed locally by processing system 100.

External processing system 180 may include processing circuitry 190, which may be any of the types of processors described above for processing circuitry 110. Processing circuitry 190 may include a semantic segmentation unit 194 configured to perform the same processes as semantic segmentation unit 140. Processing circuitry 190 may acquire camera images 168 from camera(s) 104, respectively, or from memory 160. Though not shown, external processing system 180 may also include a memory that may be configured to store camera images, model outputs, among other data that may be used in data processing. Semantic segmentation unit 194 may be configured to perform any of the techniques described as being performed by semantic segmentation unit 140. ADAS 196 may be configured to perform any of the techniques described as being performed by ADAS 142 including determination of lane marking types, lane marking position determination in relation to a subject vehicle, and determination of where a change in lane marking occurs in relation to the subject vehicle.

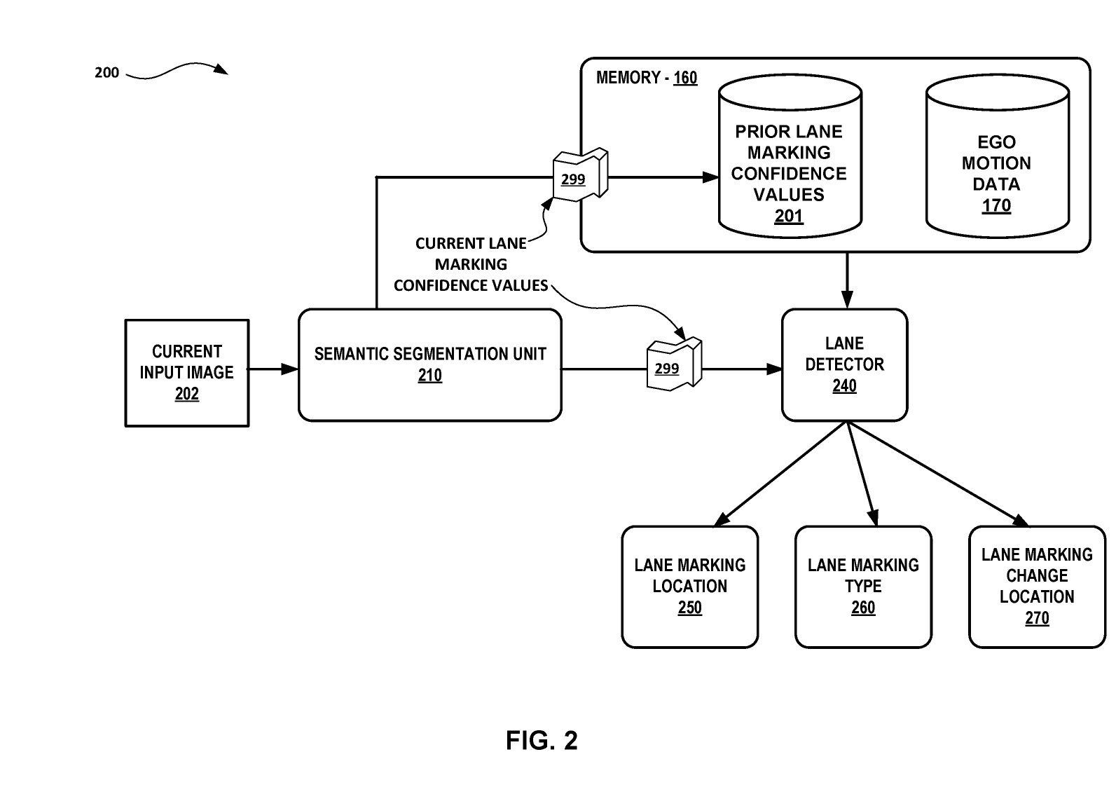

FIG. 2 is a block diagram illustrating an architecture 200 for processing a current input image 202 to generate predictions including lane marking locations and current lane marking confidence values 299 for the lane markings, in accordance with one or more techniques of this disclosure. FIG. 2 depicts current input image 202 processed by semantic segmentation unit 210 to generate current lane marking confidence values 299 for detected lane markings within the current input image 202. Current lane marking confidence values 299 output by semantic segmentation unit are stored into memory 160 by prior lane marking confidence values 201 and also provided to lane detector 240. FIG. 2 further depicts memory 160 storing ego motion data 170 (refer also to FIG. 1) providing information regarding the ego motion of a subject vehicle.

Lane detector 240 is depicted as obtaining current lane marking confidence values 299 from semantic segmentation unit 210 as well as obtaining prior lane marking confidence values 201 and ego motion data 170 from memory 160. Lane detector 240 generates various outputs, including, for example, one or more of lane marking location 250 for a detected lane marking, lane marking type 260 for the detected lane marking, and lane marking change location 270 indicating the transition point where lane markings change types (e.g., dashed to solid or solid to dashed) among the lane marking locations 250 or lane marking sampling points for the given current input image 202.

Semantic segmentation unit 210 may detect and label objects within current input image 202 and may optionally generate camera features from input images 202. During training, machine learning algorithms learn the characteristics of images from large datasets, allowing trained models to subsequently generate characteristics and features from new input images 202 obtained at inference time (e.g., such as while operating a vehicle equipped with an ADAS type processing system 100) based on generalizations learned during model training. Object detection and feature extraction techniques may utilize information within current input images 202 such as raw pixel values, mean pixel values across channels, edge detection, pixel intensity, pixel depth information, and so forth, through the application of computer vision processing.

Current input image 202 may be an example of camera images 168 of FIG. 1. As depicted here, current input image 202 is a single input image or a single frame. In other examples, multiple concurrent input images may be utilized, such as image data 302 depicted by FIG. 3, with each of the multiple images of image data 302 received from a plurality of cameras at different locations and/or different fields of view, which may be overlapping. With reference to FIG. 2, architecture 200 may process current input image 202 in real-time or near real-time so that as camera 104 captures each respective current input image 202, architecture 200 processes the captured camera image 202.

Architecture 200 may apply semantic segmentation to current input image 202 using semantic segmentation unit 210. Semantic segmentation unit 210 may generate, as output, a segmentation map. In some examples, segmentation map provides labeled regions identifying a detected class of object (e.g., lane marker, tree, car, etc.) or bounding boxes surrounding each detected object corresponding to sub-regions of current input image 202. In other examples, segmentation map provides a pixel-wise classification of current input image 202, where each pixel receives a label corresponding to a specific class, such as, road, lane markings on a road, car, tree, sky, etc. Semantic segmentation unit 210 may categorize each pixel of current input image 202 into one of several predefined classes, resulting in a labeled output image that marks regions based on their content. The final output from semantic segmentation unit 210 may be a dense pixel-level map in which each class is represented by a specific color or label.

Semantic segmentation unit 210 may provide as output a segmentation map current lane marking confidence values 299. Semantic segmentation unit 210 may write current lane marking confidence values 299 into memory, stored as prior lane marking confidence values 201.

Lane detector 240 may obtain, as input, current lane marking confidence values 299 from semantic segmentation unit 210 as well as prior lane marking confidence values 201 and ego motion data 170 from memory 160. Lane detector 240 may additionally obtain a segmentation map from semantic segmentation unit 210, when lane detector 240 is configured to perform additional semantic segmentation post processing on the segmentation map provided by semantic segmentation unit 210. In other instances, lane detector 240 operates utilizing current lane marking confidence values 299 from semantic segmentation unit 210 as well as prior lane marking confidence values 201 and ego motion data 170 from memory 160 without additional reference to the segmentation map.

In some examples, lane detector 240 applies temporal semantic segmentation to current input image 202 utilizing prior lane marking confidence values 201 to update or adjust the current lane marking confidence values 299 provided by semantic segmentation unit 210 corresponding to lane marking objects detected within current input image 202. Lane detector 240 may predict the existence of lane markings, the location of lane markings, and the type of lane markings within current input image 202 using prior lane marking confidence values 201, even when such lane markings are not directly observable within current input image 202 due to the lane markings being occluded within current input image 202 but visible within prior input images according to prior lane marking confidence values 201.

Temporal semantic segmentation extends semantic segmentation applied only to a single current input image 202 by considering not only the single current input image 202, but also a sequence of images or frames previously obtained or, as depicted here, prior lane marking confidence values 201 which were derived from the prior input images.

In such a way, lane detector 240, utilizing temporal semantic segmentation, enables consistent and accurate localization of lane marking locations 250, determination of lane marking types 260, and determination of lane marking change locations 270 for any given current input image 202 utilizing temporally relevant information over time as derived from both current input image 202 frames and prior frames. This temporal information enables the capture of motion, changes in appearance, and object continuity in the event that a lane line marking becomes partially or even fully occluded. The application of temporal semantic segmentation by lane detector 240 increases predictive accuracy by lane detector 240 when generating as output, lane marking location 250, lane marking type 260, and lane marking change location 270.

In some examples, semantic segmentation unit 210 iteratively processes each current input image 202 when available from a camera of a subject vehicle traversing a road. While each individual current input image 202 corresponds to a single point in time, multiple current input images 202 captured over time may be processed as a series of images, in which each frame (e.g., each current input image 202) is treated as part of a continuous stream, where both spatial and temporal patterns undergo analysis by lane detector 240 utilizing both the respective current lane marking confidence values 299 derived from each current input image 202 and prior lane marking confidence values 201 obtained from memory 160, with lane detector 240 additionally utilizing ego motion data 170 obtained from memory 160 for the purposes of matching current lane marking confidence values 299 and prior lane marking confidence values 201 for each corresponding lane marking detected (e.g., matching up current and prior lane marking confidence values for the same lane marking) with adjustments made for the apparent changes in position of the corresponding lane markings relative to the subject vehicle.

Lane detector 240 generates as its output, predictions and confidence values including, as depicted here, lane marking location 250 predictions, lane marking type 260 predictions, and lane marking change location 270 predictions. The output may include labels for the identified lane markings and events (e.g., change in lane marking type) as well as confidence scores that indicate the likelihood of each prediction.

Moreover, lane detector 240 may generate predictions of lane marking locations 250 within a current input image 202 even when the lane marking is fully occluded using aggregated lane marking confidence values based on combining current lane marking confidence values 299 with prior lane marking confidence values 201. Non-uniform and configurable weightings may be applied to each of current lane marking confidence values 299 with prior lane marking confidence values 201. In other instances, current lane marking confidence values 299 are averaged with prior lane marking confidence values 201. For instance, by tracking position of the lane markings in a scene relative to a subject vehicle utilizing ego motion data 170 and correlating the lane markings across iteratively processed current input image 202 frames utilizing prior lane marking confidence values 201, a lane marking having a low confidence value below a threshold or even a confidence value of zero in a current input image 202 may be weighted or averaged out using prior lane marking confidence values 201 to produce an updated lane marking location 250 prediction and lane marking type 260 prediction with high a confidence value which satisfies a higher threshold (e.g., such as 80% confidence or some other configurable threshold).

Since architecture 200 may be part of ADAS 142, 196 for controlling a vehicle, output from lane detector 240 may allow ADAS 142, 196 of FIG. 1 to control the vehicle based on the representation of the one or more predicted objects. Architecture 200 is not limited to generating lane marking locations 250, lane marking types 260, and lane marking change locations 270 for controlling a vehicle. Architecture 200 may generate lane marking locations 250, lane marking types 260, and lane marking change locations 270 for controlling another object, for updating user interface displays of a vehicle, and/or perform one or more other tasks involving image segmentation, depth detection, object detection, or any combination thereof.

In accordance with at least one example, processing circuitry 110 (see FIG. 1) may be configured to generate a final determination of whether an ADAS 142, 196 (see FIG. 1) controlled lane change may be conducted based on marking locations 250, lane marking types 260, and lane marking change locations 270. In other examples, a warning or alert may be triggered by an ADAS 142, 196 system for a human operator-initiated lane change of a vehicle which is determined by processing circuitry 110 (see FIG. 1) to be non-compliant with road markings based on marking locations 250, lane marking types 260, and lane marking change locations 270 for the subject vehicle in relation to a current location of the subject vehicle. For example, an autonomous vehicle may forgo the lane change whereas an ADAS vehicle with safety assistance features may trigger alerts, haptic vibrations to the steering wheel, resistance to steering inputs into a steering wheel, etc.

Architecture 200 may use machine learning models such as convolutional neural network (CNN) layers to analyze the input data in a hierarchical manner. The CNN layers may apply filters to capture local patterns and gradually combine them to form higher-level features. Each convolutional layer extracts increasingly complex visual representations from current input images 202.

During training, architecture 200 may be trained using a loss function that measures the discrepancy between current input images 202 and a ground truth image. This loss guides the learning process, encouraging the encoder to capture meaningful features and the decoder to produce more accurate reconstructions. The training process may involve minimizing the difference between the generated image and the ground truth image, typically using backpropagation and gradient descent techniques.

FIG. 3 is a flow diagram illustrating view transformation using image data 302 having multiple input images, sensor inputs, or both, to determine a lane marking change location, in accordance with one or more techniques of this disclosure. The functions of the flow diagram of FIG. 3 may be implemented using processing circuitry 110, external processing system 180, and lane detector 192, 197 of FIG. 1.

Image data 302 may be obtained, for instance, from one or more cameras, one or more sensors, and may include any combination of static images, video imagery, LiDAR information, GPS information, radar information, etc.

Whereas semantic segmentation unit 210 of FIG. 2 is configured to iteratively process each individual current input image 202 one by one, the architecture of FIG. 3 may be utilized to process image data 302 having multiple current camera images and optionally additional sensor data from multiple cameras and sensors for a given point in time (e.g., for a current iteration of image data 302). Image data 302 is provided as input to image view network 303 which extracts camera features 304 including lane markings and other information from image data 302. Such camera features 304 are provided as input to BEV projection unit 310. As depicted here, BEV projection unit 310 obtains camera features 304 and projects camera features 304 into real world coordinates (312). For instance, BEV projection unit 310 may perform depth estimate (313) and project image features 304 into a BEV image space (314) to generate a current BEV image space 345. For instance, BEV projection unit 310 may be configured to fuse the 2D camera features from the 2D coordinate grid of the original input image to form 3D Bird’s Eye View (BEV) features within current BEV image space 345.

Camera features 304 generated or extracted by image view network 303 may be provided as input into BEV projection unit 310. Generally speaking, BEV projection unit 310 converts data from the real world as represented by extracted camera features 304 and converts that information into something that can be used by processing system 100 (see FIG. 1) for downstream computer vision operations. The specific techniques used for image view network 303 and BEV projection unit 310 depend on the particular application and the characteristics of the input data (e.g., images, video frames, depth maps).

In the context of computer vision, image view network 303 processes images from different viewpoints or perspectives to enhance understanding and representation of the visual content. Image view network 303 enables the interpretation of spatial relationships and dynamics of objects from various angles, such as in 3D object recognition, autonomous driving, or scene reconstruction.

Image view network 303 processes image data 302 from multiple images and sensor data captured from different camera and sensor viewpoints, enabling learning of camera features 304 that represent the same object or scene from diverse perspectives. Image view network 303 may extract relevant camera features 304 from multiple input images and sensor data represented by image data 302. By aggregating camera features 304 across different views, image view network 303 creates a more comprehensive representation of the objects or scenes being analyzed and improves consistency across views.

BEV projection unit 310 may apply geometric transformations to input images to align them to a common reference frame or perspective. This process may involve operations such as rotation, scaling, or translation to ensure that images from different viewpoints within image data 302 remain comparable. BEV projection unit 310 adjusts the perspective of the various images and sensor data to simulate a uniform viewpoint.

FIG. 3 further depicts semantic segmentation unit 315 configured to obtain current BEV image space 345 from BEV projection unit 310 and generate current lane marking confidence values 399 corresponding to detected lane marking objects segmented from current BEV image space 345. Current lane marking confidence values 399 are stored into memory 160 as prior lane marking confidence values 301 for subsequent reference. Current lane marking confidence values 399 are additionally provided as output from semantic segmentation unit 315 to lane detector unit 320 as input.

Lane detector unit 320 obtains prior lane marking confidence values 301 and ego motion data 170 from memory 160, as well as current lane marking confidence values 399 from semantic segmentation unit 315. Lane detector unit 320 generates predictions 331 as output. For instance, lane detector unit 320 may determine lane marking locations 322, determine lane marking types 323, and determine lane marking change locations 324 as output predictions 331.

Lane detector unit 320 may perform localization operations for lane marking objects identified by semantic segmentation unit 315 based on, for example, ego motion data 170 representing the relative movement of a subject vehicle relative to an environment captured by image data 302. Lane detector unit 320 may compare current lane marking confidence values 399 with prior lane marking confidence values 301. Lane detector unit 320 may obtain and utilize ego motion data 170 to compensate for apparent changes in position of lane markings within a forward view of the vehicle to enable matching between current lane marking confidence values 399 with prior lane marking confidence values 301.

Predictions 331 output by lane detector unit 320, including determined lane marking change locations (324) may be provided to ADAS 142, 196 (see FIG. 1) to enable control of a vehicle or to provide input to driver assistance features. A simple example of ADAS 142, 196 (see FIG. 1) utilizing predictions 331 from lane detector unit 320 to safely path through an environment includes, by way of example, identifying where a change to lane marking types occurs, maintaining a position within a lane, identifying and acting appropriately to road signals such as stop signs and stop lights, and avoiding detected objects corresponding to other vehicles, pedestrians, bicycles, and so forth. Path planning and navigation operations may utilize predictions 331 from lane detector unit 320 to facilitate path planning algorithms by providing a structured representation of obstacles, drivable areas, and other relevant features to generate safe, efficient, and legally compliant trajectories (e.g., changing lanes over dashed lane line markings before the lane markings transition to solid, stopping at a red light even when a path is clear, etc.), for the vehicle or robot to follow.

Predictions 331 may enable various useful tasks and useful output for further downstream computer vision operations, such as object detection, object localization, object segmentation, pathing operations including facilitating safe and legally compliant lane changes and outputting for display, high accuracy representations of lane markings, lane marking locations (322), lane marking types (323), an lane marking change locations (324) to a user interface (e.g., such as a user interface displaying a top-down view of an environment surrounding a vehicle), etc.

Lane detector unit 320 is configured to provide increased prediction accuracy for lane markings represented within current BEV image space 345, including for partially or fully occluded lane markings, utilizing temporal semantic segmentation information available from memory 160 including prior lane marking confidence values 301 and ego motion data 170.

Lane detector unit 320 enables continuity of lane tracking over time, even when lane markings become occluded within a current frame of image data 302 or within future frames of image data 302 due to a vehicle or another obstruction. Temporal semantic segmentation information is utilized to address these challenges by enabling ongoing computation of accurate lane marking confidence values despite possible lane marking occlusions present within current real-time information.

Subsequent processing by semantic segmentation unit 315 may encounter current image data 302 having lane markings which are occluded due to a vehicle physically covering the lane markings. Current lane marking confidence values 399 from such current image data 302 may therefore yield poor determinations, such as 50% confidence that a lane marking is solid and 50% confidence that a lane marking is dashed, or in other situations, a lane marking may be entirely indeterminable from current image data 302.

By combining current lane marking confidence values 399 with prior lane marking confidence values 301, lane detection unit 320 is enabled to compare current and prior lane marking confidence values to yield greater prediction accuracy.

Lane markings may be sampled at equispaced intervals over time as captured by iterative image data 302 inputs. In some examples, the position of a subject vehicle is aligned with the lane marking positions determined by lane detector unit 320 using ego motion data 170 to enable matching of current and past detected lane markings or to enable comparisons between current lane marking confidence values 399 with prior lane marking confidence values 301 for a same or corresponding lane marking object represented within both current and prior interactions of captured image data 302. In each new frame obtained from image data 302, the position of the subject vehicle is updated based on its motion in the frame, enabling the real-world position of the lane markings to be recalculated relative to the new position of the vehicle and to allow for the matching, correspondence, and/or association of the same lane marking objects across past, present, and future instances of image data 302 captured by the subject vehicle. A continuous evaluation of the lane marking measurements over the entire observable path of travel (e.g., the track of the vehicle) may be conducted to determine whether the lane markings remain consistent over the observed distance or if there is a change to the lane markings, such as a transition from solid to dashed markings or vice versa. Because the position of the vehicle is tracked relative to the lane markings, when lane detector unit 320 determines a change to lane marking type 323, lane detector unit 320 also determines lane marking change location 324 relative to the vehicle.

For instance, lane detector unit 320 may identify the point of change by comparing past and current lane marking confidence levels before and after each possible transition point. Consider a specific example for transitioning from dashed lane line markings to solid lane line markings. Each point along a path of travel may be assessed as a potential candidate for a change from dashed to solid lane line markings. An iterative process evaluates all points by calculating the mean confidence for dashed markings before the candidate change point and the mean confidence for solid markings after the candidate change point.

The difference, or delta, between the solid and dashed confidence levels is then calculated for both before and after the candidate change point. When the delta meets a predefined threshold, the candidate point is selected as the determined lane marking change location (324) indicating the transition point between dashed and solid markings. The sign of the delta, whether positive or negative, indicates whether the transition is from solid to dashed or from dashed to solid.

In some examples, current frames with visible lane markings within image data 302 are compared with prior frames that have not yet passed the vehicle as represented by prior lane marking confidence values 301. Once the vehicle passes a lane marking, prior lane marking confidence values 301 for frames associated with those markings are discarded, and their confidence information is no longer considered in future evaluations as their weighting will be irrelevant to the presence, type, and location of lane line markings observable (or occluded) within current image data 302.

FIG. 4 is a conceptual diagram for generating accurate lane marking confidence values using temporal semantic segmentation information, in accordance with one or more techniques of this disclosure. More particularly, FIG. 4 depicts lane detection unit 420 operating to combine temporal semantic segmentation information 450 from current BEV image space 445A and prior BEV image space 445B. For instance, current BEV image space 445A is depicted as having occluded lane markings 459 due to the presence of a vehicle within the forward view physically obstructing the lane line markings for a current input image. However, that vehicle may not have occluded the lane markings in a prior view. Therefore, lane detection unit 420 may combine, average, or weight the occluded lane marking 459 features of current BEV image space 445A using temporal semantic segmentation information 450 from prior BEV image space 445. Specifically, lane detection unit 420 may apply prior lane marking confidence values 461 from prior BEV image space 445B as weightings to the corresponding features of current BEV image space 445A to improve predictive accuracy associated with the occluded lane markings 459.

According to aspects of the disclosure, a number of measurements (points in the world) may be detected and associated with each lane line in each frame within current BEV image space 445A and prior BEV image space 445B. Measurements corresponding to prior lane marking confidence values 461 from prior BEV image space 445B are then used to update the estimated lane line functions y(x) and z(x). The measurements may contain information derived from semantic segmentation images, providing prior lane marking confidence values 461 regarding whether a particular measurement, point, region, object, or pixel corresponds to a dashed or solid lane marking.

Access to the motion of the ego vehicle between frames is provided to lane detection unit 420, allowing measurements to be transformed across different points in time. In particular, lane detection unit 420 may match prior lane marking confidence values 461 with current lane marking confidence values using the ego motion data of the vehicle. Accumulating temporal information about the lane line marking type at various points in space and time, using data sampled from semantic segmentation images over time, enables the estimation of the marking type and also enables the determination of the point at which the lane marking type may change, even when the point is currently occluded within a current input image or within current BEV image space 445A, provided that the point was previously observed within prior BEV image space 445B.

For instance, for each input frame, every nth measurement associated with the track is uniformly sampled. The position (x, y, z) of each measurement is captured and stored to prior frame confidence values 198 (see FIG. 1), along with the confidence that the measurement corresponds to either a solid or dashed marking or some other lane marking property being observed. For each new input frame, the position of each previously recorded measurement is updated based on the vehicle’s motion since the last frame. This allows information about occluded lane markings 459 at a previously observed but now occluded point to be retained. If a measurement falls behind the vehicle after motion compensation, that measurement is discarded as it will no longer be relevant to lane type and position determinations.

Using this information accumulated over time, null hypothesis testing may be performed. For instance, the null hypothesis assumes that all measurements correspond to the same marking type (solid or dashed). The alternate hypothesis assumes that the measurements originate from detected lane marking objects containing multiple types.

When the null hypothesis holds, all saved measurements are utilized to estimate the type of lane marking. This may be achieved by taking the mean confidence for each type within the measurements. For instance, if the mean solid confidence is larger than the mean dashed confidence, the lane markings for the track (e.g., path) of the vehicle are classified as solid.

Conversely, if the null hypothesis is discarded, the conclusion is that the lane markings along the track for the vehicle’s path of travel changes their type at some point along the sampled measurements. Computational efficiency may be increased by forcing an assumption that only one such point exists within a current forward view for the vehicle and that the track does not transition back and forth, for instance, from dashed to solid and back to dashed again.

The conclusion that the lane markings along the track for the vehicle’s path of travel change their type may then be followed by two operations, estimating distance (e.g., location) and estimating the lane time. For instance, the first operation estimates or determines lane marking change location 324 (see FIG. 3) corresponding to the location at which point the lane marking changes type based on the distance to that location. The second operation determines lane marking types 323 (see FIG. 3) corresponding to the two identified types of lane markings before and after the point at which the lane markings changed types.

The distance at which the lane marking changes type may be estimated using the following technique: Assume that each sample point is a candidate transition point between the marking types. For each point, the mean confidence for the lane marking being solid or dashed is computed using the points before and after it, respectively. These values are then stored to prior frame confidence values 198 (see FIG. 1). The transition point between the two marking types is identified as the point where the difference between the mean solid and mean dashed confidence is maximized between the two intervals before and after. The point separating these intervals is designated as the transition point representing the determined lane marking change location 324 (see FIG. 3). The type corresponding to the maximal mean confidence value for the respective intervals is selected. From this, the transition between determined lane marking types 323 (see FIG. 3) may be deduced, for example, from dashed to solid or from solid to dashed, and the separating point is output as the location where the transition occurs.

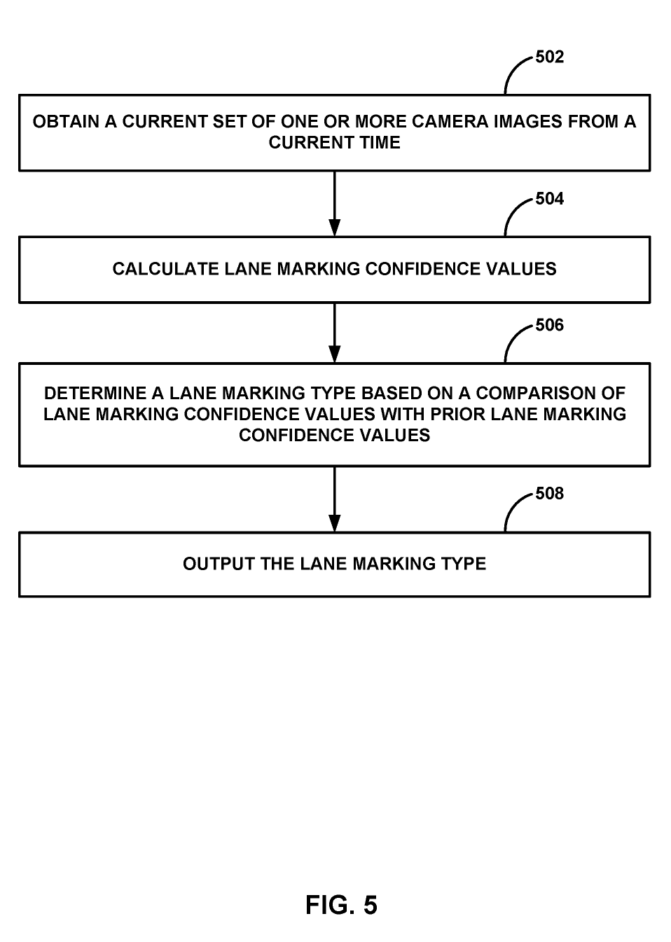

FIG. 5 is a flow diagram illustrating an example method for detecting and estimating lane line markings and lane marking type changes using temporal semantic segmentation information, in accordance with one or more techniques of this disclosure. FIG. 5 is described with respect to processing system 100 and external processing system 180 of FIG. 1, architecture 200 of FIG. 2, and the methods discussed in FIGS. 3 and 4. However, the techniques of FIG. 5 may be performed by different components of processing system 100, external processing system 180, architecture 200, or by additional or alternative systems.

Processing circuitry 110 may be configured to obtain a current set of one or more camera images 168 from a current time (502). According to such an example, processing circuitry 110 may be configured to calculate lane marking confidence values (504). For instance, processing circuitry may be configured to calculate respective lane marking confidence values for two or more lane marking types at a plurality of positions in a scene captured by the current set of one or more camera images 168.

Processing circuitry 110 may be configured to determine a lane marking type based on a comparison of lane marking confidence values with prior lane marking confidence values (506). For instance, processing circuitry may be configured to determine a lane marking type for each of the plurality of positions based on a comparison of the respective lane marking confidence values with previously-stored lane marking confidence values associated with the plurality of positions in the scene.

In some examples, processing circuitry 110 is configured to output the lane marking type (508). For instance, processing circuitry 110 may be configured to output the lane marking type for each of the plurality of positions in the scene.

In other examples, processing circuitry 110 is configured to output predictions which may be utilized for downstream useful tasks such as pathing, object segmentation, object detection and localization, decision making for autonomous vehicles and robots, etc.

Additional aspects of the disclosure are detailed in numbered clauses below.

Clause 1 – An apparatus for processing image data, the apparatus comprising: a memory for storing the image data; and processing circuitry in communication with the memory, wherein the processing circuitry is configured to: obtain a current set of one or more camera images of the image data from a current time; calculate respective lane marking confidence values for two or more lane marking types at a plurality of positions in a scene captured by the current set of one or more camera images; determine a lane marking type for each of the plurality of positions based on a comparison of the respective lane marking confidence values with previously-stored lane marking confidence values associated with the plurality of positions in the scene; and output the lane marking type for each of the plurality of positions in the scene.

Clause 2 – The apparatus of clause 1, wherein the processing circuitry is further configured to: determine a location of a lane marking change from a first lane marking type to a second lane marking type; and output the location of the lane marking change.

Clause 3 – The apparatus of clauses 1 or 2, wherein to output the location of the lane marking change, the processing circuitry is configured to: output the location of the lane marking change location indicating a first change type from solid lane markings to dashed lane markings; or output the location of the lane marking change indicating a second change type from dashed lane markings to solid lane markings.

Clause 4 – The apparatus of any combination of clauses 1-3, wherein to calculate the respective lane marking confidence values for the two or more lane marking types at the plurality of positions in the scene captured by the current set of one or more camera images, the processing circuitry is further configured to: apply semantic segmentation to a single current image corresponding to the current set of one or more camera images from the current time to generate: a lane marking object located at each of the plurality of positions in the scene captured by the current set of one or more camera images; a first confidence value indicating a probability the lane marking object located at each of the plurality of positions in the scene corresponds to a first one of the two or more lane marking types; and a second confidence value indicating the probability the lane marking object located at each of the plurality of positions in the scene corresponds to a second one of the two or more lane marking types; and wherein to determine the lane marking type for each of the plurality of positions, the processing circuitry is further configured to: determine the lane marking type for each of the plurality of positions based on a comparison of the first confidence value and the second confidence value with the previously-stored lane marking confidence values associated with the plurality of positions in the scene.

Clause 5 – The apparatus of any combination of clauses 1-4, wherein the processing circuitry is further configured to: generate camera features from the current set of one or more camera images corresponding to the two or more lane marking types at the plurality of positions in the scene captured by the current set of one or more camera images; project the camera features into a birds-eye-view (BEV) image space; and wherein to calculate the respective lane marking confidence values for the two or more lane marking types at the plurality of positions in the scene captured by the current set of one or more camera images, the processing circuitry is configured to: apply semantic segmentation to the BEV image space to generate the respective lane marking confidence values for the two or more lane marking types.

Clause 6 – The apparatus of any combination of clauses 1-5: wherein the plurality of positions in the scene captured by the current set of one or more camera images includes one or more occluded lane markings; and wherein the processing circuitry is further configured to: output a predicted lane marking type for the one or more occluded lane markings based on the comparison of the respective lane marking confidence values corresponding to the one or more occluded lane markings with previously-stored lane marking confidence values associated with the plurality of positions in the scene.

Clause 7 – The apparatus of any combination of clauses 1-6, wherein the processing circuitry is further configured to: update position information of a vehicle relative to the lane marking type output for each of the plurality of positions in the scene; and discard previously-stored lane marking confidence values associated with the plurality of positions in the scene determined to be located behind the vehicle based on the position information as updated for the vehicle.

Clause 8 – The apparatus of any combination of clauses 1-7, wherein the processing circuitry is further configured to: match the respective lane marking confidence values calculated for the two or more lane marking types at the plurality of positions in the scene captured by the current set of one or more camera images with the previously-stored lane marking confidence values associated with the plurality of positions in the scene using ego motion of a vehicle that captured the set of one or more camera images.

Clause 9 – The apparatus of any combination of clauses 1-8, wherein to output the lane marking type for each of the plurality of positions in the scene includes the processing circuitry configured to output one of: the lane marking type indicating a first change type to attention markings preceding a toll gate; the lane marking type indicating a second change type to crosswalk markings preceding a crosswalk; the lane marking type indicating a third change type to construction markings preceding a construction zone; or the lane marking type indicating a fourth change type to tunnel markings preceding a tunnel.

Clause 10 – The apparatus of any combination of clauses 1-9, wherein the processing circuitry is further configured to: detect a vehicle initiating a maneuver to change lanes or overtake; and output a determination whether the maneuver is permissible based on the lane marking type output for at least one of the plurality of positions in the scene.

Clause 11 – The apparatus of any combination of clauses 1-10, wherein the processing circuitry and the memory are part of an advanced driver assistance system (ADAS).

Clause 12 – The apparatus of any combination of clauses 1-11, wherein the processing circuitry is configured to use the lane marking type output for each of the plurality of positions in the scene to control a vehicle.

Clause 13 – The apparatus of any combination of clauses 1-2, wherein the apparatus further comprises: one or more cameras affixed to a vehicle configured to capture the current set of one or more camera images from the current time; and wherein the one or more cameras affixed to the vehicle capture a forward view of an environment surrounding the vehicle.

Clause 14 – A method of processing image data comprising: obtaining a current set of one or more camera images of the image data from a current time; calculating respective lane marking confidence values for two or more lane marking types at a plurality of positions in a scene captured by the current set of one or more camera images; determining a lane marking type for each of the plurality of positions based on a comparison of the respective lane marking confidence values with previously-stored lane marking confidence values associated with the plurality of positions in the scene; and outputting the lane marking type for each of the plurality of positions in the scene.

Clause 15 – The method of clause 14: determining a location of a lane marking change from a first lane marking type to a second lane marking type; and outputting the location of the lane marking change.

Clause 16 – The method of clauses 14 or 15, further comprising: outputting the location of the lane marking change location indicating a first change type from solid lane markings to dashed lane markings; or outputting the location of the lane marking change indicating a second change type from dashed lane markings to solid lane markings.

Clause 17 – The method of any combination of clauses 14-16, wherein calculating the respective lane marking confidence values for the two or more lane marking types at the plurality of positions in the scene captured by the current set of one or more camera images, further comprises: applying semantic segmentation to a single current image corresponding to the current set of one or more camera images from the current time and generating: a lane marking object located at each of the plurality of positions in the scene captured by the current set of one or more camera images; a first confidence value indicating a probability the lane marking object located at each of the plurality of positions in the scene corresponds to a first one of the two or more lane marking types; and a second confidence value indicating the probability the lane marking object located at each of the plurality of positions in the scene corresponds to a second one of the two or more lane marking types; and wherein determining the lane marking type for each of the plurality of positions, further comprises: determining the lane marking type for each of the plurality of positions based on a comparison of the first confidence value and the second confidence value with the previously-stored lane marking confidence values associated with the plurality of positions in the scene.

Clause 18 – The method of any combination of clauses 14-17, further comprising: generating camera features from the current set of one or more camera images corresponding to the two or more lane marking types at the plurality of positions in the scene captured by the current set of one or more camera images; projecting the camera features into a birds-eye-view (BEV) image space; and wherein calculating the respective lane marking confidence values for the two or more lane marking types at the plurality of positions in the scene captured by the current set of one or more camera images, includes: applying semantic segmentation to the BEV image space to generate the respective lane marking confidence values for the two or more lane marking types.

Clause 19 – The method of any combination of clauses 14-18: wherein the plurality of positions in the scene captured by the current set of one or more camera images includes one or more occluded lane markings; and wherein the method further comprises: outputting a predicted lane marking type for the one or more occluded lane markings based on the comparison of the respective lane marking confidence values corresponding to the one or more occluded lane markings with previously-stored lane marking confidence values associated with the plurality of positions in the scene.

Clause 20 – A non-transitory computer-readable medium storing instructions that, when executed, cause processing circuitry to: obtain a current set of one or more camera images from a current time; calculate respective lane marking confidence values for two or more lane marking types at a plurality of positions in a scene captured by the current set of one or more camera images; determine a lane marking type for each of the plurality of positions based on a comparison of the respective lane marking confidence values with previously-stored lane marking confidence values associated with the plurality of positions in the scene; and output the lane marking type for each of the plurality of positions in the scene.

Clause 21 – A computer program product comprising one or more instructions that, when executed by at least one processor, causes the at least one processor to perform any of the methods of clauses 14-19.

Clause 22 – An apparatus comprising means for performing any combination of techniques of clauses 14-19.

It is to be recognized that depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing image data, the apparatus comprising:
a memory for storing the image data; and
processing circuitry in communication with the memory, wherein the processing circuitry is configured to:
obtain a current set of one or more camera images of the image data from a current time;
calculate respective lane marking confidence values for two or more lane marking types at a plurality of positions in a scene captured by the current set of one or more camera images;
determine a lane marking type for each of the plurality of positions based on a comparison of the respective lane marking confidence values with previously-stored lane marking confidence values associated with the plurality of positions in the scene; and
output the lane marking type for each of the plurality of positions in the scene.

2. The apparatus of claim 1, wherein the processing circuitry is further configured to:
determine a location of a lane marking change from a first lane marking type to a second lane marking type; and
output the location of the lane marking change.

3. The apparatus of claim 2, wherein to output the location of the lane marking change, the processing circuitry is configured to:
output the location of the lane marking change location indicating a first change type from solid lane markings to dashed lane markings; or
output the location of the lane marking change indicating a second change type from dashed lane markings to solid lane markings.

4. The apparatus of claim 1, wherein to calculate the respective lane marking confidence values for the two or more lane marking types at the plurality of positions in the scene captured by the current set of one or more camera images, the processing circuitry is further configured to:
apply semantic segmentation to a single current image corresponding to the current set of one or more camera images from the current time to generate:
a lane marking object located at each of the plurality of positions in the scene captured by the current set of one or more camera images;
a first confidence value indicating a probability the lane marking object located at each of the plurality of positions in the scene corresponds to a first one of the two or more lane marking types; and
a second confidence value indicating the probability the lane marking object located at each of the plurality of positions in the scene corresponds to a second one of the two or more lane marking types; and
wherein to determine the lane marking type for each of the plurality of positions, the processing circuitry is further configured to:
determine the lane marking type for each of the plurality of positions based on a comparison of the first confidence value and the second confidence value with the previously-stored lane marking confidence values associated with the plurality of positions in the scene.

5. The apparatus of claim 1, wherein the processing circuitry is further configured to:
generate camera features from the current set of one or more camera images corresponding to the two or more lane marking types at the plurality of positions in the scene captured by the current set of one or more camera images; and
project the camera features into a birds-eye-view (BEV) image space; and
wherein to calculate the respective lane marking confidence values for the two or more lane marking types at the plurality of positions in the scene captured by the current set of one or more camera images, the processing circuitry is configured to:
apply semantic segmentation to the BEV image space to generate the respective lane marking confidence values for the two or more lane marking types.

6. The apparatus of claim 1:
wherein the plurality of positions in the scene captured by the current set of one or more camera images includes one or more occluded lane markings; and
wherein the processing circuitry is further configured to:
output a predicted lane marking type for the one or more occluded lane markings based on the comparison of the respective lane marking confidence values corresponding to the one or more occluded lane markings with previously-stored lane marking confidence values associated with the plurality of positions in the scene.

7. The apparatus of claim 1, wherein the processing circuitry is further configured to:
update position information of a vehicle relative to the lane marking type output for each of the plurality of positions in the scene; and
discard previously-stored lane marking confidence values associated with the plurality of positions in the scene determined to be located behind the vehicle based on the position information as updated for the vehicle.

8. The apparatus of claim 1, wherein the processing circuitry is further configured to:
match the respective lane marking confidence values calculated for the two or more lane marking types at the plurality of positions in the scene captured by the current set of one or more camera images with the previously-stored lane marking confidence values associated with the plurality of positions in the scene using ego motion of a vehicle that captured the set of one or more camera images.

9. The apparatus of claim 1, wherein to output the lane marking type for each of the plurality of positions in the scene includes the processing circuitry configured to output one of:
the lane marking type indicating a first change type to attention markings preceding a toll gate;
the lane marking type indicating a second change type to crosswalk markings preceding a crosswalk;
the lane marking type indicating a third change type to construction markings preceding a construction zone; or
the lane marking type indicating a fourth change type to tunnel markings preceding a tunnel.

10. The apparatus of claim 1, wherein the processing circuitry is further configured to:
detect a vehicle initiating a maneuver to change lanes or overtake; and
output a determination whether the maneuver is permissible based on the lane marking type output for at least one of the plurality of positions in the scene.

11. The apparatus of claim 1, wherein the processing circuitry and the memory are part of an advanced driver assistance system (ADAS).

12. The apparatus of claim 1, wherein the processing circuitry is configured to use the lane marking type output for each of the plurality of positions in the scene to control a vehicle.

13. The apparatus of claim 1, wherein the apparatus further comprises:
one or more cameras affixed to a vehicle configured to capture the current set of one or more camera images from the current time; and
wherein the one or more cameras affixed to the vehicle capture a forward view of an environment surrounding the vehicle.

14. A method of processing image data comprising:
obtaining a current set of one or more camera images of the image data from a current time;
calculating respective lane marking confidence values for two or more lane marking types at a plurality of positions in a scene captured by the current set of one or more camera images;
determining a lane marking type for each of the plurality of positions based on a comparison of the respective lane marking confidence values with previously-stored lane marking confidence values associated with the plurality of positions in the scene; and
outputting the lane marking type for each of the plurality of positions in the scene.

15. The method of claim 14:
determining a location of a lane marking change from a first lane marking type to a second lane marking type; and
outputting the location of the lane marking change.

16. The method of claim 14, further comprising:
outputting a location of the lane marking change location indicating a first change type from solid lane markings to dashed lane markings; or
outputting the location of the lane marking change indicating a second change type from dashed lane markings to solid lane markings.

17. The method of claim 14, wherein calculating the respective lane marking confidence values for the two or more lane marking types at the plurality of positions in the scene captured by the current set of one or more camera images, further comprises:
applying semantic segmentation to a single current image corresponding to the current set of one or more camera images from the current time and generating:
a lane marking object located at each of the plurality of positions in the scene captured by the current set of one or more camera images;
a first confidence value indicating a probability the lane marking object located at each of the plurality of positions in the scene corresponds to a first one of the two or more lane marking types; and
a second confidence value indicating the probability the lane marking object located at each of the plurality of positions in the scene corresponds to a second one of the two or more lane marking types; and
wherein determining the lane marking type for each of the plurality of positions, further comprises:
determining the lane marking type for each of the plurality of positions based on a comparison of the first confidence value and the second confidence value with the previously-stored lane marking confidence values associated with the plurality of positions in the scene.

18. The method of claim 14, further comprising:
generating camera features from the current set of one or more camera images corresponding to the two or more lane marking types at the plurality of positions in the scene captured by the current set of one or more camera images; and
projecting the camera features into a birds-eye-view (BEV) image space; and
wherein calculating the respective lane marking confidence values for the two or more lane marking types at the plurality of positions in the scene captured by the current set of one or more camera images, includes:
applying semantic segmentation to the BEV image space to generate the respective lane marking confidence values for the two or more lane marking types.

19. The method of claim 14:
wherein the plurality of positions in the scene captured by the current set of one or more camera images includes one or more occluded lane markings; and
wherein the method further comprises:
outputting a predicted lane marking type for the one or more occluded lane markings based on the comparison of the respective lane marking confidence values corresponding to the one or more occluded lane markings with previously-stored lane marking confidence values associated with the plurality of positions in the scene.

20. A non-transitory computer-readable medium storing instructions that, when executed, cause processing circuitry to:
obtain a current set of one or more camera images from a current time;
calculate respective lane marking confidence values for two or more lane marking types at a plurality of positions in a scene captured by the current set of one or more camera images;
determine a lane marking type for each of the plurality of positions based on a comparison of the respective lane marking confidence values with previously-stored lane marking confidence values associated with the plurality of positions in the scene; and
output the lane marking type for each of the plurality of positions in the scene.
